(19) United States
(12) Patent Application Publication
(10) Pub. No.: US 2017/0253024 A1
(43) Pub. Date: Sep. 7, 2017

(54) APPARATUS AND METHOD FOR PRINTING ON NON-CYLINDRICAL SURFACES HAVING CIRCULAR SYMMETRY

(71) Applicant: INX International Ink Co., Schaumburg, IL (US)

(72) Inventors: John Randel LaCaze, Hampton Cove, AL (US); Fenlong Lin, Madison, AL (US); Jay Banta Larsen, Huntsville, AL (US)

(21) Appl. No.: 15/449,639

(22) Filed: Mar. 3, 2017

Related U.S. Application Data
(60) Provisional application No. 62/303,151, filed on Mar. 3, 2016.

(51) Int. Cl. B41J 2/045; B41J 3/407

(52) U.S. Cl. CPC B41J 2/04505; B41J 2/04586; B41J 3/4073

(57) ABSTRACT

A apparatus and method for printing an image on a non-cylindrical circularly symmetrical surface of an object using a printhead with inkjet nozzles with tips in a nozzle plane by rotating the object about the longitudinal axis of the surface while a print engine controller drives the printhead in space and controls the operation of the nozzle tips within a predetermined print gap along the surface to print the image.

### CROSS-REFERENCE TO RELATED APPLICATIONS

This application claims priority to U.S. Provisional Application 62/303,151 filed Mar. 3, 2016, and which is incorporated by reference.

### BACKGROUND

The present invention relates generally to printing and, more particularly, to inkjet printing on non-cylindrical surfaces having circular symmetry about their longitudinal axis including regular conical, irregular conical, and radiused surfaces of cups, bottles and other containers, and baseball bats.

Methods of printing on cylindrical objects via digital printing with commercial inkjet printheads are known in the art. These methods include depositing print dots on cylindrical objects at a uniform line screen spacing and dot size from an inkjet printhead for a given desired screened color or solid color. These prior methods present quality and efficiency issues when employed to print on non-cylindrical surfaces having circular symmetry about their longitudinal axis including regular and irregular conical surfaces and on radiused surfaces having circular symmetry.

For present purposes, the surfaces to be printed on are non-cylindrical and have circular symmetry about their longitudinal axis. These include conical surfaces with a flat base and a longitudinal axis which is a straight line about which the conical surface has a circular symmetry. The conical surfaces include regular conical surfaces which are three-dimensional surfaces that taper smoothly from a flat circular base to a point spaced from the base (the apex) through which the longitudinal axis passes and they have a circular symmetry about the axis. They also include truncated regular conical surfaces which are regular conical surfaces cut off below the apex by a plane parallel to the base that forms a circular truncated top edge. They further include irregular conical surfaces which are three-dimensional surfaces that have a flat base and a longitudinal axis which is a straight line about which the base and the conical surface has a circular symmetry but these surfaces do not taper smoothly from the base to the apex but rather bow in or out with respect to the longitudinal axis. The radiused surfaces addressed here also have a circular symmetry about a central longitudinal axis. Current methods for printing on cylindrical surfaces are not suited for printing on such non-cylindrical surfaces having circular symmetry because they cannot maintain good distortion-free printed images along such surfaces with consistent screened and solid color, image clarity and print efficiency.

Current apparatus and methods of printing on cylindrical surfaces via digital printing with commercial inkjet printheads limit the positioning of the printhead relative to the cylindrical surface to be printed upon to rotary motion of the cylindrical surface and axial motion of the printhead relative to the longitudinal axis of the cylindrical surface at a set spacing relative to the cylindrical surface. If such cylindrical printing methods were applied to printing on non-cylindrical surfaces having circular symmetry about their longitudinal axes, jetting of ink from the printhead inkjets onto such surfaces would be deficient since the spacing of the inkjets as the printhead advances relative to the longitudinal axis of these surfaces would either increase or decrease from the ideal or required spacing as printing by way of axial motion of the printhead proceeds. The varying spacing will cause image distortion. This distortion may manifest itself as variable mechanical dot gain (actual ink dot size differing from intended dot size), optical dot gain or veiling (loss of sharpness in dot circumference), dot elongation (intended circular dots elongated to ellipse-like dots), and dot misplacement (dots not on image where intended).

FIG. 1 illustrates why these problems arise in the application of such prior art cylindrical printing apparatus and methods to printing on a truncated regular conical surface 12 of a three-dimensional object 10 which may be a cup. Cup 10 has a circular base 14 with a circumference 15, a circular top 16 with a circumference 17 and a central longitudinal axis 18 which extends from the base to the top. During printing, cup 10 is rotated by the apparatus in direction 19 about axis 18. A printhead 20 of the apparatus is illustrated schematically in FIG. 1 with at least one row of inkjet nozzles along a line 22 at the bottom of the printhead. The printhead may have multiple rows of inkjet nozzles disposed in a plane. The line (or plane) of printhead nozzles 22 is arranged parallel to longitudinal axis 18 of cup 10.

During printing, the apparatus will advance printhead 20 in direction 24 along a straight line 26 parallel to longitudinal axis 18. The spacing of the line (or plane) of inkjet nozzles 22 from surface 12 as printing begins at circumference 17 of surface 12 is “A”, as shown. As printing proceeds and the printhead advances in direction 24, this spacing increases until it reaches circumference 15 of surface 12 where the distance from the printhead and the cylindrical surface at circumference 15 is a larger spacing “B”. Because of the increasing spacing from surface 12 as the printhead advances from circumference 17 to circumference 15 the quality of the printed image will decrease with increasing distance from the conical surface which causes distortion in the final printed image. The image distortion is due to, inter alia, variable mechanical dot gain, increasing optical dot gain or veiling, dot elongation and dot misplacement.

Additionally since screened color printing is a function of line screen (dots per linear measure or dot spacing) and dot size, where screened images are desired, applying a fixed combination of dots per linear distance and a fixed dot size as in such prior art cylindrical printing will also compromise image quality and consistency along the changing diameters of non-cylindrical surfaces. At most, only a small area of the non-cylindrical screened printed surface will accurately contain the targeted screened color, while the screened image on the remaining print area will vary due to the increasing inkjet nozzle spacing, likely producing undesired visual effects. This is true also of the line screen and dot size combinations required to obtain solid colors given that those colors are achieved with combinations of only a few standard colors (typically cyan, magenta, yellow and black). These deficiencies will be apparent by spectrophotometric measurement in a CIE Lab color space or the like, by colorimetric measurement in an RGB color space or the like, as well as by simple visual inspection.

These and other drawbacks arise if conventional apparatus and method for digital inkjet printing on cylindrical surfaces are applied to printing on non-cylindrical and radiused surfaces having circular symmetry because the print distance between the surface of the object to be printed and the printhead inkjet nozzles are mechanically fixed in such prior art systems. Even where the distance between the surface of the object to be printed and the printhead may be changed manually for different sized cylindrical objects, manually adjustable cylindrical printing systems are not suited to printing on non-cylindrical surfaces having circular symmetry since it would be extremely difficult if not impossible to manually adjust printhead positioning in a way that maintains inkjet nozzle spacing and hence image quality along an entire non-cylindrical surface.

### SUMMARY

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in ways that combine features of various embodiments and still be within the scope contemplated by the appended claims.

Embodiments of the present invention include apparatus and methods for efficiently and accurately printing on non-cylindrical surfaces having circular symmetry about their longitudinal axes including regular and irregular conical surfaces and radiused surfaces. In all embodiments it is understood that non-cylindrical surfaces having circular symmetry about their longitudinal axes that are being printed upon may terminate at a point along the object and continue along the object as a cylindrical printing surface or as further similar or differing non-cylindrical surfaces having circular symmetry. Unlike where cylindrical printing methods are applied to printing on such non-cylindrical surfaces having circular symmetry about their longitudinal axes, embodiments maintain high quality intended screened and solid color images on the surfaces being printed. Embodiments also produce consistent targeted screened color along the varying cross-sections of the non-cylindrical surfaces printed upon. Embodiments also maintain accurate solid color where desired along the varying cross-sections diameters of the non-cylindrical surfaces via color builds by varying the line print resolution and/or dot size to minimize the variation that would occur if a printing method/apparatus designed for cylindrical surfaces were used.

In accordance with embodiments of the present methods and apparatus, the dimensions and contours or geometry of the non-cylindrical surface having circular symmetry about its longitudinal axis that is to be printed upon is either entirely determined and characterized in a corresponding data set before the printing process commences or is determined and characterized in whole or in part as printing proceeds along the surface. The data characterizing the geometry is used by a print engine controller to drive the positioning of the printhead in space vis-a-vis the non-cylindrical surface to be printed upon to maintain as constant and uniform spacing as possible between the inkjet nozzles of the printhead triggered to produce the image and the surface.

A printhead with at least one row of inkjet nozzles arranged in a straight line will be used and preferably the printhead may have multiple longitudinally disposed parallel rows of nozzles arranged in a plane. For example, there may be 500 nozzles in each row. Where two or more rows of nozzles are present with their nozzle tips arranged in a plane, the nozzles in each row may be evenly offset with respect to each other. For example, the printhead may have two parallel rows of 500 nozzles each at a spacing from each other of about 140 μm where the spacing between the rows is about 4.8 mm and the nozzles in each row are evenly offset with respect to each other.

The uniform spacing (“print gap”) between the nozzle tips and the non-cylindrical surface being printed upon will be a predetermined print gap range based on the geometry of the surface being printed upon and the image being applied that is will maximize the quality of the printed image. The print gap range will ideally be no more than up to 5 mm and preferably will be about 1-2 mm. Accordingly, where the printhead includes a single row of inkjet nozzles with the nozzle tips arranged in a straight line or adjacent rows of inkjet nozzles with their nozzle tips disposed in a plane, only nozzles with nozzle tips within the print gap will be triggered. Thus, the number and location of printhead inkjet nozzles selected by the print engine controller to be triggered at any point during the printing process will vary depending on, inter alia, the curvature of the portion of the surface being printed upon and the location of the portion of the surface being printed upon that is closest to the nozzle tip line or plane.

Surface geometry data sets may be obtained or calculated from drawings of the non-cylindrical surface of the object being printed upon, for example from computer-generated object drawings. Surface geometries may also be determined, in whole or in part, by sensors positioned ahead of the inkjet printhead which determine the dimensions and contours of the non-cylindrical surface and provide characterizing data instantaneously as the printhead advances relative to the surface being printed upon. Such sensors include, but are not limited to, optical and laser proximity sensors available in the art.

In accordance with embodiments of this invention, a system is provided in which an object with a non-cylindrical surface having circular symmetry about its longitudinal axis that is to be printed upon is mounted in an apparatus for rotation along its longitudinal axis while a digital inkjet printhead is mounted for movement in the X, Y and Z axes as necessary to maintain a uniform print gap or print gap range between inkjet printhead nozzles and the surface while printing proceeds as the printhead advances parallel to the longitudinal axis of the rotating object. As will be illustrated below, in embodiments this includes varying the positioning of the printhead to maintain a constant spacing between selected nozzle tips within the print gap and opposite portions of a regular conical surface of an object while the object rotates about its longitudinal axis. In other embodiments, the print engine will pivot the printhead so that the longitudinal axis of the printhead is perpendicular to the longitudinal axis of the surface to continue printing from selected nozzle tips within the print gap while accommodating sharp bends in or between irregular conical surfaces and radiused surfaces that might otherwise interfere with the movement of the printhead during the printing process.

The spatial movement of the digital inkjet printhead in the X, Y and Z axes (and the object being printed on) may be accomplished by positioning means including, for example, robotically-actuated systems or robotic arms, linear actuators and motors, and rotary encoders adjustable in the X, Y and Z directions operated by the print engine controller. In embodiments the printhead may be mounted on a carriage or an arm associated with such printhead positioning means.

It is further understood that, while it is preferred that the object surface being printed upon rotate along its longitudinal axis but otherwise be fixed in space while the printhead is moved about in space to maintain a uniform print gap from its non-cylindrical circularly symmetric surface, in alternative embodiments, the object (and therefore the surface to be printed) may be moved in space (while it is rotated about the longitudinal axis of the printed surface) and the printhead fixed or both the object and the printhead moved in space to achieve the same relative motion. In all cases a print engine controller maintains the relative motion and as close as possible to a uniform print gap (or gap range) between the printhead nozzle tips in the print gap and the surface being printed upon by those selected printhead nozzles.

In embodiments, the movement of the printhead relative to the non-cylindrical circularly symmetrical surface of the object being printed on is driven by a print engine controller having a CPU core, memory devices, and appropriate software and interfaces which receives and uses the data set defining the surface geometry to drive the printhead positioning means and operate the printhead during the printing process. This data set may be input before printing begins or it may comprise instantaneous surface geometry information provided to the print engine by a proximity sensor associated with the printhead.

The print engine controller takes as input the data defining the surface geometry and the image which is to be printed and uses this input to map the colors, positions and sizes of the image colored dots which are to be laid down on the non-cylindrical surface to the geometry of the surface. It then drives the positioning of the printhead in space and the selection and timing of the jetting from the inkjet nozzles as required to produce a quality image with the desired dot size, dot shape, and dot placement, and where appropriate line print resolution. In embodiments the printhead controller drives not only the number and positioning of the printed ink dots to take account of the varying cross-section diameters of the non-cylindrical surface being printed upon, but it will also continuously adjust line screen and dot size as the cross-section diameters of the non-cylindrical surface being printed upon increase or decrease under the advancing inkjet printhead.

### BRIEF DESCRIPTION OF THE DRAWINGS

In order to aid in understanding the invention, it will be described in connection with exemplary embodiments with reference to the accompanying drawings in which like numbers will be given to like features in the accompanying drawings wherein:

FIG. 1 is a schematic view of a prior art system for printing on cylindrical surfaces;

FIG. 2 is a schematic view of aspects of an embodiment of the present method and apparatus for printing on a truncated regular cylindrical surface and FIG. 2A is a partial bottom plan view of a portion of the printhead used showing two rows of parallel offset printhead nozzles tips;

FIGS. 3A-3C are schematic views of aspects of an embodiment of the present invention illustrating printing on a bottle having a cylindrical portion and a bowed irregular conical portion, and FIG. 3D is a bottom plan view of a portion of the printhead used showing two rows of offset printhead nozzle tips;

FIG. 4 is a schematic view of aspects of an embodiment of the present invention illustrating printing on a bottle having cylindrical and differing bowed portions; and

FIGS. 5A-5G are schematic views of aspects of an embodiment of the present invention illustrating printing on surfaces of an object with varying cylindrical and non-cylindrical surfaces.

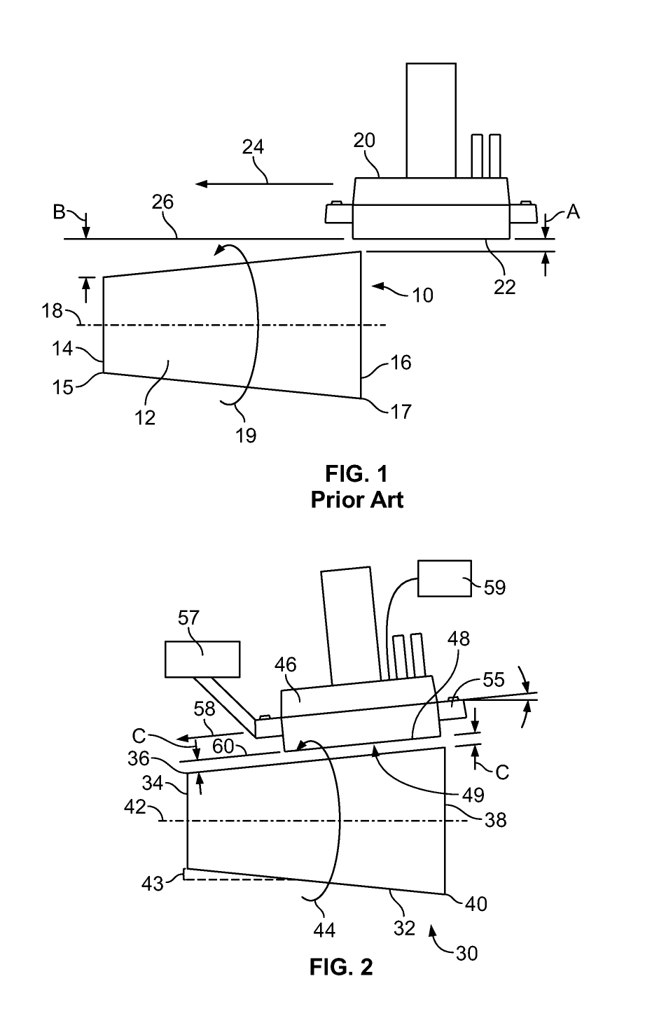

### DETAILED DESCRIPTION

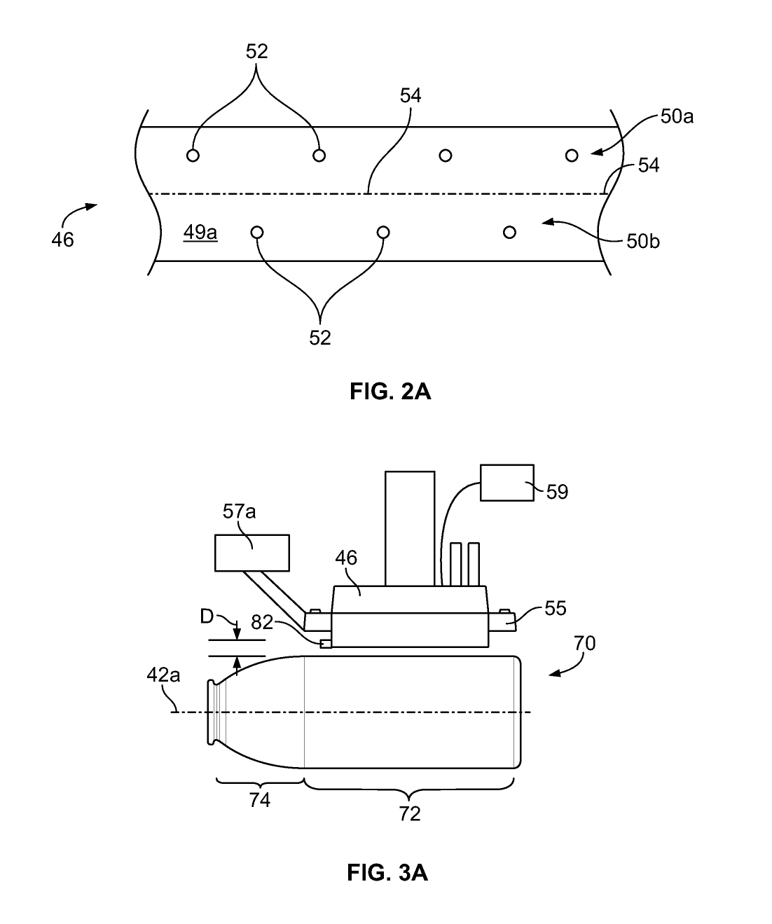

Various embodiments of the invention may be understood by referring to FIGS. 2-5. Throughout the figures, like numerals may be used for corresponding features. Embodiments of this invention may be provided in other specific forms without departing from the characteristics thereof as described herein. The embodiments described are not to be considered restrictive.

Referring now to FIG. 2, an embodiment of a digital printing apparatus for printing on a truncated regular cylindrical surface 32 of a three-dimensional object 30 which may be a cup is shown. Cup 30 has a circular truncated base 34 with a circumference 36, a circular top 38 with a circumference 40 and a central longitudinal axis 42 which extends from the base to the top. Conical surface 32 is at an angle 43 with respect to axis 42. During printing, cup 30 is rotated by the apparatus in the direction 44 about longitudinal axis 42.

A printhead 46 of the apparatus is illustrated schematically in FIG. 2 with rows of inkjet nozzles having nozzle tips in a plane depicted at edge 48 in FIG. 2 at the bottom 49 of the printhead. A single line of inkjet nozzles may alternatively be present at the bottom of the printhead parallel to edge 48. A portion of bottom 49 of the printhead is shown in FIG. 2A with two partial rows 50a and 50b of schematically depicted parallel inkjet nozzle tips 52 lying in a nozzle tip plane 49a (appearing as edge 48 in FIG. 2). Inkjet nozzle tips 52 are generally evenly spaced from an inkjet configuration centerline 54 in plane 49a.

Printhead 46 of FIG. 2 is supported on a carriage 55 of the apparatus associated with printhead positioning means 57 chosen from among, e.g., robotically actuated systems and robotic arms, linear actuators/motors and rotary encoders. As can be seen in this figure, the printhead positioning means moves the carriage (and therefore the printhead) about in space to position nozzle tip plane 49a at angle 43 with respect to axis 42 which corresponds to the angle of surface 32 with respect to cup longitudinal axis 42. Plane 49a (FIG. 2A) is at the same time oriented so corresponding nozzle row tips on opposite sides of centerline 54 are equidistant from surface 32.

Printhead 46 is driven by a print engine controller 59. The print engine controller includes a CPU core, memory devices and appropriate software and interfaces to receive and store information defining the surface geometry of cup 30 and the image to be applied to the cup surface. The print engine controller maps the colors, positions and sizes of the color dots which are to be laid down on the cup surface and drives the printhead to form the desired image on the non-cylindrical cup surface with appropriate ink dot sizes, dot shapes and dot placement.

During printing, printhead 46 will be driven by the print engine controller in direction 58 along a straight line 60 parallel to surface 32. The spacing or print gap of the inkjet centerline from surface 32 as printing begins at circumference 40 of surface 32 is “C”, as shown. As printing proceeds and the printhead advances in direction 58 along line 60, this print gap remains uniform until the printhead reaches circumference 36 of surface 32. Maintaining a uniform spacing or print gap “C” during the entire printing operation while mapping the colors, positions, quantity and sizes of the color dots applied by the printhead to the contours of the surface being printed upon helps ensure the application of a high quality undistorted and color accurate image.

As noted above, the print gap between the printhead nozzle tips and the non-cylindrical surface being printed upon will be a predetermined range based on the geometry of the surface being printed upon and the image being applied. The print gap will be or is chosen to maximize the quality of the printed image. While FIG. 2 is not to scale, it should be understood that the print gap in this figure is 1.5 mm. Also, the number and location of ink jet nozzles selected by the print engine controller to be triggered at any point during the printing process will vary depending on the curvature of the portion of the surface being printed upon. In the embodiment of FIG. 2, the entirety of the nozzle tip plane is parallel to surface 32 and therefore all nozzles in the nozzle tip plane located opposite the surface printed upon at any point in time are subject to being triggered as appropriate to produce the desired image.

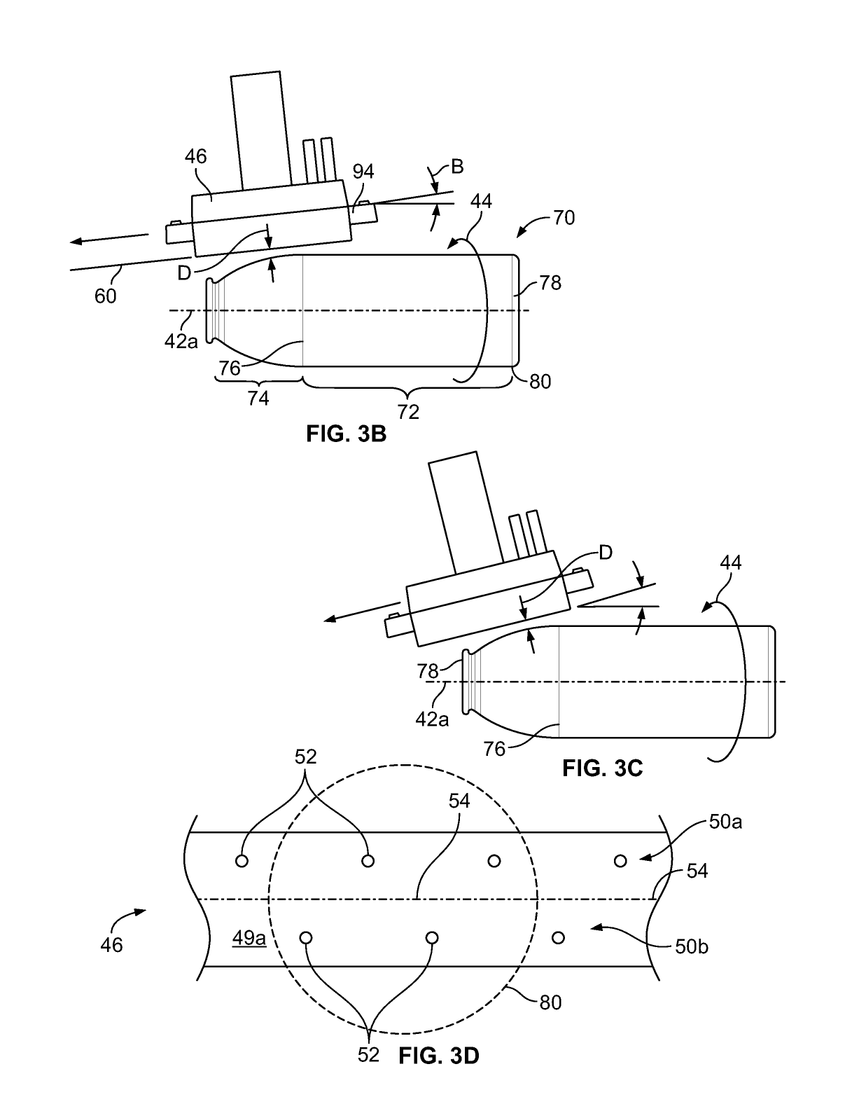

FIGS. 3A-3C illustrate an embodiment in which a printed image is applied to a bottle 70 having a longitudinal axis 42a with a cylindrical portion 72 and an outwardly bowed irregular conical portion 74 having a circular symmetry about the longitudinal axis. A printhead 46 as in FIG. 2 is schematically depicted in these figures. The printhead has two rows of nozzles with nozzle tips disposed and distributed in a plane as described above with respect to FIGS. 2 and 2A. As also described with respect to FIG. 2, printhead 46 is supported on a carriage 55 associated with printhead positioning means 57a which in this case comprises a robotic arm that moves the carriage and hence the nozzle tip plane about in space as printing proceeds as depicted in FIGS. 3A-3C.

Printhead positioning means 57a is controlled by a schematically depicted print engine 59. This print engine contains information defining the surface geometry of the bottle and the image which is to be printed on it and maps the colors, positions and sizes of the colored dots which are to be laid down on the surface to coordinate the positioning of the printhead in space and the timing and other parameters controlling the jetting from the inkjet nozzles as required to produce a quality image on the bottle with the desired size, shape and placement.

Turning first to FIG. 3A, the bottom of the printhead (and hence the printhead nozzle tip plane 49a (FIG. 3D)) is oriented parallel to longitudinal axis 42a with a print gap “D” selected to be in the range 1.0-1.6 mm between the nozzle tip plane and the surface of the cylindrical portion. Appropriate nozzles are triggered by the print engine controller while the printhead advances along portion 72 parallel to axis 42a and bottle 70 is rotated about axis 42a . This printhead includes a sensor 82 positioned ahead of the printhead to determine the dimensions and contours of the surface of bottle 70 and provide geometric characterizing data instantaneously as the printhead advances relative to the bottle surface.

When the leading nozzles of the nozzle tip plane reach circumference 76 at the distal end of cylindrical portion 72, the printhead positioning means will tilt the printhead with respect to axis 42a as necessary to maintain print gap “D” between the nozzle tip plane and outwardly bowed irregular conical portion 74 of the bottle. Intermediate positions of the printhead along the outwardly bowed irregular conical portion are shown in FIGS. 3B and 3C. When the printhead clears distal end 78 of the bottle, it will return to an appropriate start position for printing on either an identical or a different non-cylindrical surface having a circular symmetry.

As noted above, the number and location of ink jet nozzles selected by the print engine controller to be triggered at any point during the printing process will vary depending on the curvature of the portion of the surface being printed upon. In the embodiment of FIGS. 3A-3C, only a portion of the nozzle tip plane falls within the specified print gap of 1.0-1.6 mm during printing on bottle portion 74 and therefore only these nozzle tips are selected and triggered by the print engine controller to lay down the desired image on the outwardly bowed irregular conical portion 74 of bottle 70. Nozzle tips 52 in the area 80 of FIG. 3D comprise the selected and triggered nozzles.

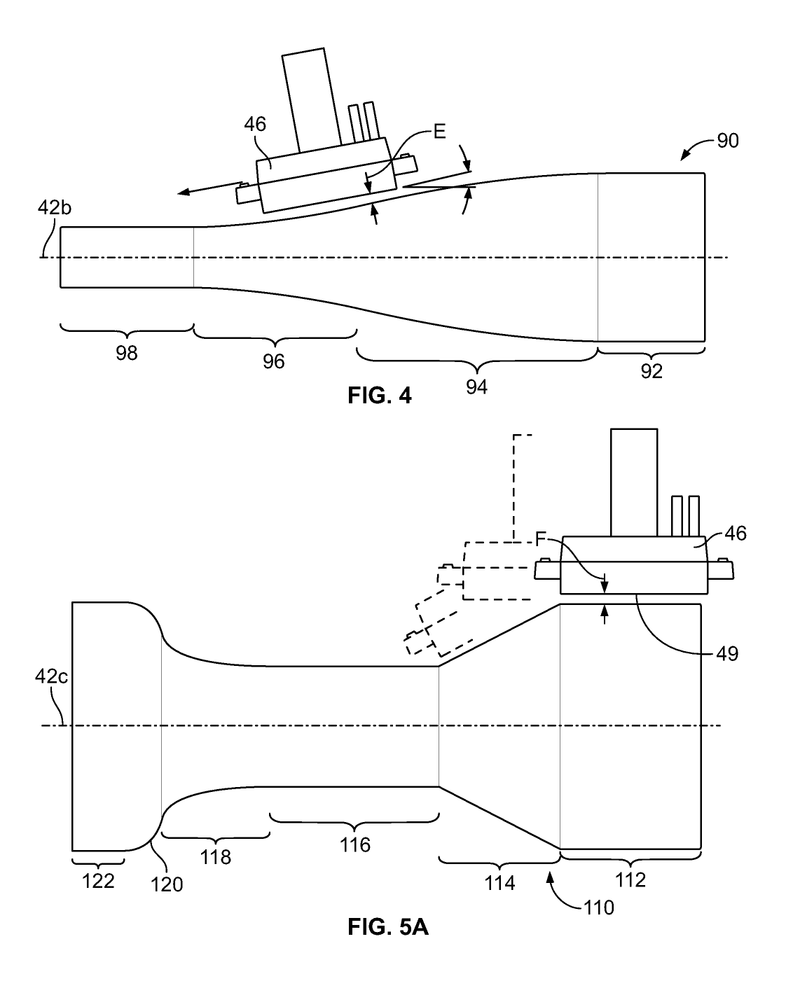

FIG. 4 provides another differently shaped bottle 90 with a longitudinal axis 42b for printing in accordance with an embodiment. Bottle 90 has a cylindrical portion 92 at its proximal end, an outwardly bowed irregular conical portion 94 distal to the portion 92, an inwardly bowed irregular conical portion 96 distal to the outwardly bowed irregular conical portion, and a distal second cylindrical portion 98 having a diameter substantially smaller than cylindrical portion 92. Printhead 46 is shown in this figure at an intermediate location along the surface of the bottle as it advances from the proximal to the distal end of the bottle. Print gap “E” is maintained along the surface of the bottle during the entire printing procedure to ensure a high quality printed image.

In this embodiment, a print gap of 1.1-1.6 mm was selected to ensure an optimal printed image. As the printing proceeds, only a portion of the nozzle tip plane falls within this gap and therefore only a selected grouping of nozzle tips are triggered by the print controller. Also, the print controller may select different groupings of nozzle tips as they come within the gap at different points along the surface being printed on.

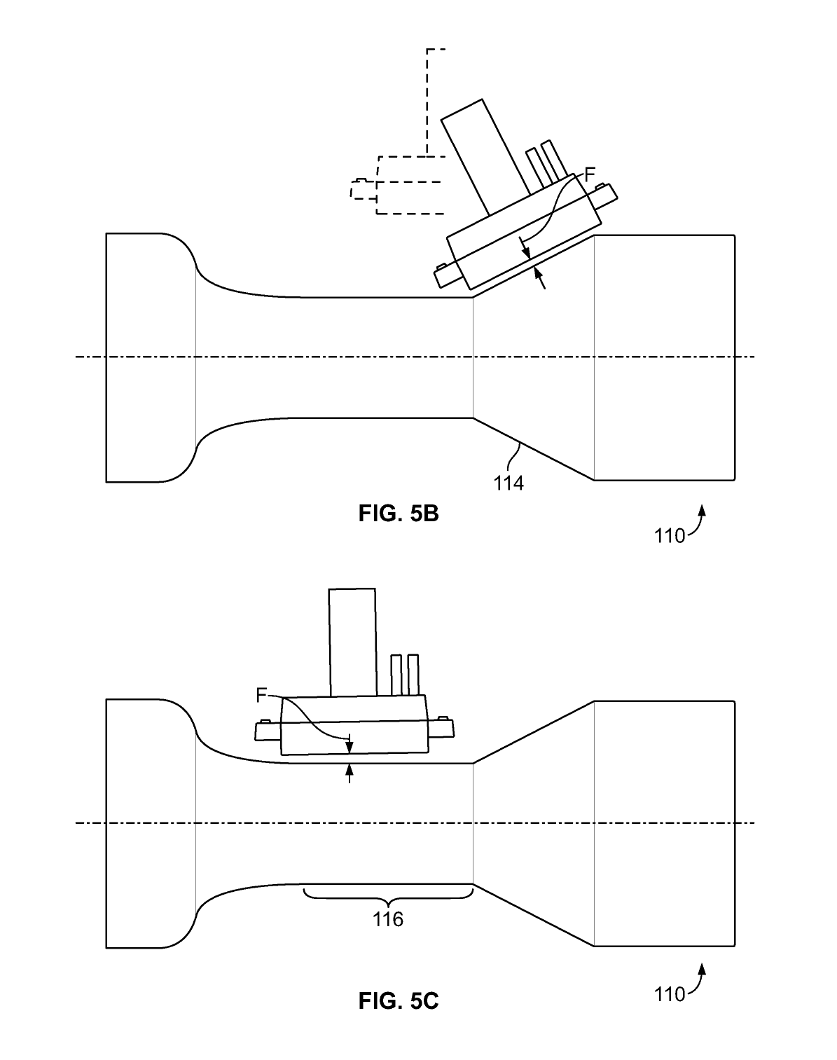

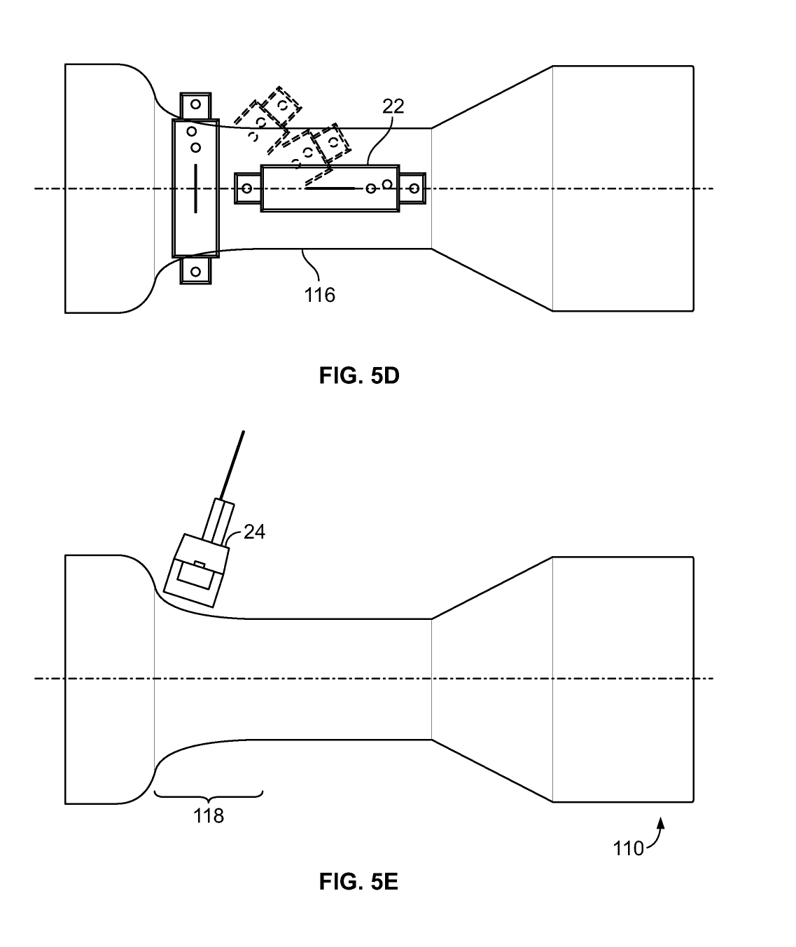

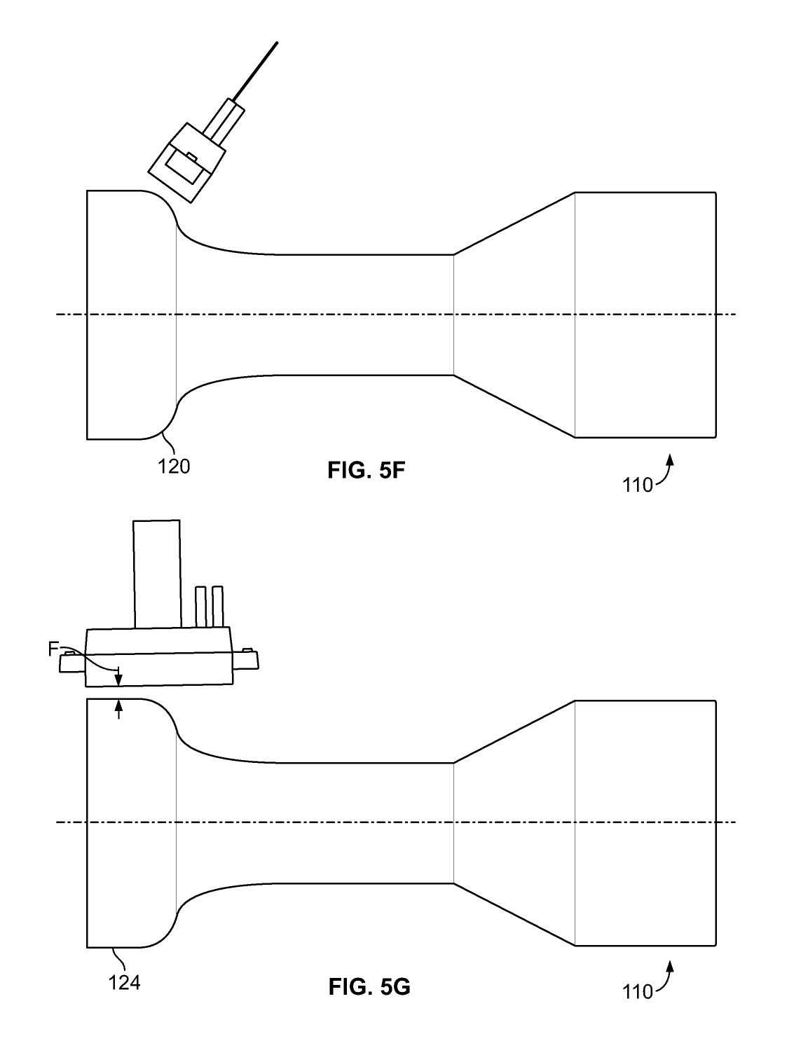

FIGS. 5A-5F demonstrate the operation of the invention in printing on a complex surface of an object 110 including cylindrical, conical, inwardly bowed irregular conical and radiused surfaces. Object 110, which has a longitudinal axis 42c, includes a first cylindrical portion 112, a regular conical portion 114, a second cylindrical portion 116, an inwardly bowed irregular conical portion 118, an outwardly radiused portion 120, and a third cylindrical portion 122. Printhead 46 is shown in an initial position in FIG. 5A with the plane of its nozzle heads 49 spaced from the surface of first cylindrical portion 112 at a print gap “F” which will be maintained in the range of 1.3-1.8 mm. As can be seen in FIGS. 5A-5C, the printhead proceeds along cylindrical and conical portions 112, 114 and 116 with the longitudinal axis of the elongated printhead in a plane containing longitudinal axis 42c of the object. However, when the printhead reaches portion 118 the printhead is rotated 90° as shown in FIG. 5D so that it can more closely track and print (FIG. 5E) along the contour of this section of the object, and then continue printing along radius portion 120 while maintaining inkjet nozzles running across the printhead within the print gap. Finally, when the printhead reaches third cylindrical portion 122, it rotates back 90° to complete printing the image in this area.

The method of an embodiment may be described broadly as involving the following steps 130-144:

| Step | Description |
|---|---|
| 130 | Select object with non-cylindrical circularly symmetric |
| | printing surface |
| 132 | Determine contours of printing surface |
| 134 | Select image to be printed on printing surface |
| 136 | Map image to contours of printing surface |
| 138 | Select a printing gap along the printing surface to produce |
| | a proper image |
| 140 | Position a printhead with inkjet nozzles in the printing gap |
| 142 | Rotate the printing surface about its longitudinal axis |
| 144 | Print the image onto the printing surface by advancing the |
| | printhead along the longitudinal axis while moving the printhead in |
| | space along the contours of the printing surface and triggering the |
| | inkjet nozzles in the printing gap to print the image on the |
| | printing surface |

The contours of the printing surface determined in step 132 may be obtained or calculated from drawings of the non-cylindrical surface such as from computer-generated object drawings or the contour may be determined, in whole or in part, by a proximity sensor that maps the surface contours ahead of printing the image onto the printing surface. Also, the movement of the printing surface and the printhead in step 142 may be interchanged, so that, for example, the printing surface is stationary and the printhead also rotates about the longitudinal axis of the printing surface. The movement of the printing surface and the printhead may also be interchanged in step 144 by holding the printhead stationary and achieving the same relative motion by moving the printing surface.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the embodiments of the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What we claim is:

1. An apparatus for printing an image with uniform screened and/or solid colors on a non-cylindrical circularly symmetrical surface of an object comprising:
means for rotating the object about the longitudinal axis of the non-cylindrical circularly symmetrical surface;
an inkjet printhead having inkjet nozzles with nozzle tips arranged in a nozzle plane at the bottom of the printhead;
printhead positioning means for moving the printhead in space in the X, Y and Z directions as necessary to advance the printhead along the longitudinal axis while maintaining a uniform print gap between nozzle tips in the nozzle plane and the non-cylindrical circularly symmetrical surface; and
a print engine controller for driving the printhead positioning means and controlling the nozzles to apply the image to the surface.

2. The apparatus of claim 1 in which the object is stationary and the printhead positioning means also rotates the printhead about the longitudinal axis of the surface.

3. The apparatus of claim 1 in which the nozzle tips are arranged in a straight line at the bottom of the printhead.

4. The apparatus of claim 1 including means for generating a data set describing the dimensions and contours of the non-cylindrical circularly symmetrical surface where the printhead controller maps the image to the surface before applying the image thereto.

5. The apparatus of claim 4 in which the data set is generated from drawings of the non-cylindrical circularly symmetrical surface.

6. The apparatus of claim 4 in which the data set is generated from computer-generated object drawings of the non-cylindrical circularly symmetrical surface.

7. The apparatus of claim 4 including a proximity sensor located adjacent the printhead that generates the data set.

8. The apparatus of claim 1 in which the print engine controller determines a print gap range between the nozzle tips and the surface and only inkjet nozzles within the print gap range are permitted to form the image.

9. The apparatus of claim 4 in which the mapping includes mapping colors, positions and sizes of image colored dots.

10. A method of printing an image with uniform screened and/or colors on a non-cylindrical circularly symmetrical surface of an object comprising:
mounting the object for rotation about the longitudinal axis of the circularly symmetrical surface;
characterizing the geometry of the non-cylindrical circularly symmetrical surface;
providing an inkjet printhead having inkjet nozzles with nozzle tips arranged in a plane at the bottom of the printhead;
providing a print engine controller for moving the printhead in space in the X, Y and Z directions and advancing the printhead along the longitudinal axis to print the image while maintaining a uniform print gap between nozzle tips in the nozzle plane and the non-cylindrical circularly symmetrical surface.

11. The method of claim 10 in which the object is kept stationary and the printhead also rotates about the longitudinal axis of the surface.

12. The method of claim 10 in which the printhead is kept stationary and the object is moved in space in the X, Y and Z directions as necessary to advance the printhead along the longitudinal axis while maintaining a uniform print gap between nozzle tips in the nozzle plane and the surface.

13. The method of claim 10 in which the nozzle tips are arranged in a straight line at the bottom of the printhead.

14. The method of claim 10 in which a data set describing the dimensions and contours of the non-cylindrical circularly symmetrical surface is generated and the printhead controller maps the image to the surface before applying the image thereto.

15. The method of claim 10 in which a print gap range between the nozzle tips and the surface is determined and only inkjet nozzles within the print gap range are permitted to form the image.

16. The method of claim 10 in which the printhead is positioned across the surface of the object during printing.
